(19) United States
(12) Patent Application Publication
(10) Pub. No.: US 2020/0211195 A1
(43) Pub. Date: Jul. 2, 2020

(54) ATTACHED OBJECT DETECTION APPARATUS

(71) Applicant: DENSO TEN Limited, Kobe-shi (JP)

(72) Inventors: Nobuhisa IKEDA, Kobe-shi (JP); Nobunori ASAYAMA, Kobe-shi (JP); Takashi KONO, Kobe-shi (JP); Yasushi TANI, Kobe-shi (JP); Daisuke YAMAMOTO, Kobe-shi (JP); Tomokazu OKI, Kobe-shi (JP); Teruhiko KAMIBAYASHI, Kobe-shi (JP)

(73) Assignee: DENSO TEN Limited, Kobe-shi (JP)

(21) Appl. No.: 16/690,561

(22) Filed: Nov. 21, 2019

(30) Foreign Application Priority Data
Dec. 28, 2018 (JP) 2018-248577

(51) Int. Cl. G06T 7/11; G06T 7/194; G06T 7/12; G06K 9/00; G06T 7/254

(52) U.S. Cl. CPC G06T 7/11; G06T 7/194; G06T 7/12; G06T 2207/10016; G06T 7/254; G06T 2207/10024; G06K 9/00805

(57) ABSTRACT

An attached object detection apparatus includes a memory and a controller coupled to the memory. The controller is configured to: extract one or more candidate regions from a captured image captured by an image capturing apparatus, each of the one or more candidate regions being a candidate for being an attached object region corresponding to a portion of the image in which an attached object is attached to the image capturing apparatus, the one or more candidate regions being extracted based on edges detected from pixels of the image; select, as one or more selection regions, one or more of the candidate regions satisfying predetermined selection conditions, from amongst the extracted one or more candidate regions; and determine, based on fluctuation of luminance distribution of pixels in the selected one or more selection regions, whether or not each of the one or more selection regions is the attached object region.

### BACKGROUND OF THE INVENTION

### Field of the Invention

The invention relates to an attached object detection apparatus and an attached object detection method.

### Description of the Background Art

Conventionally, an attached object detection apparatus has been known that detects an object attached to a lens of a camera based on chronological change in luminance of a divided region generated by dividing a region of an image captured by the camera.

One example of the objects (attached objects) on the lens is a snow melting agent and the like that reflects light outside a vehicle so that a portion of the captured image behind the attached object (also referred to below as “background image”) temporarily cannot be seen. There is a case in which the attached object does not reflect light so that the background image can be seen through the attached object. Therefore, it is preferable to detect an attached object like a snow melting agent only when the attached object reflects light so that the captured image temporarily cannot be seen, and when the attached object does not reflect light, it is preferable not to detect the attached object.

### SUMMARY OF THE INVENTION

According to one aspect of the invention, an attached object detection apparatus includes a memory and a controller coupled to the memory. The controller is configured to: extract one or more candidate regions from a captured image captured by an image capturing apparatus, each of the one or more candidate regions being a candidate for being an attached object region corresponding to a portion of the captured image in which an attached object is attached to the image capturing apparatus, the one or more candidate regions being extracted based on edges detected from pixels of the captured image captured by the image capturing apparatus; select, as one or more selection regions, one or more of the candidate regions satisfying predetermined selection conditions that include a region size and a descriptive statistics value, from amongst the extracted one or more candidate regions; and determine, based on fluctuation of luminance distribution of pixels in the selected one or more selection regions, whether or not each of the one or more selection regions is the attached object region.

Thus, an object of the invention is to provide an attached object detection apparatus and an attached object detection method to accurately detect an attached object.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 illustrates an outline of an attached object detection method of this embodiment;

FIG. 2 is a block diagram showing a configuration of an attached object detection apparatus of this embodiment;

FIG. 3 illustrates a row of pixels to be extracted for luminance distribution;

FIG. 4 illustrates a process performed by a calculator;

FIG. 5 illustrates the process performed by the calculator;

FIG. 6 illustrates a process performed by a determiner;

FIG. 7 illustrates the process performed by the determiner;

FIG. 8 illustrates the process performed by the determiner;

FIG. 9 illustrates the process performed by the determiner;

FIG. 10 illustrates the process performed by the determiner;

FIG. 11 illustrates a process performed by the determiner; and

FIG. 12 is a flowchart showing process steps of an attached object detection process that is performed by the attached object detection apparatus of this embodiment.

### DESCRIPTION OF THE EMBODIMENTS

An attached object detection apparatus and an attached object detection method of the embodiment will be described with reference to the attached drawings. The present invention will not be limited by the embodiment described below.

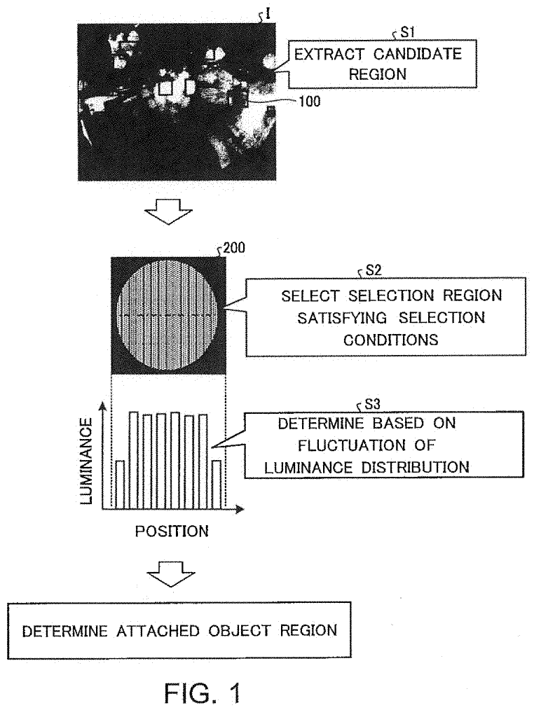

First, an outline of the attached object detection method of this embodiment will be described with reference to FIG. 1. FIG. 1 illustrates the outline of the attached object detection method of this embodiment. FIG. 1 illustrates a captured image I that is captured while having, for example, a snow melting agent, an attached object, on a lens of a camera. The captured image I in FIG. 1 shows a case in which a background image cannot be seen in a region having the snow melting agent because outside light is reflected on the snow melting agent.

For example, the attached object, such as a snow melting agent, reflects the outside light so that the region of the snow melting agent becomes a high luminance region. Thus, the background image temporarily cannot be seen. In a case where the attached object does not reflect the light, the region of the snow melting agent becomes a low luminance region so that the background image may be seen through the attached object. Therefore, in a case of the attached object such as the snow melting agent, it is preferable to detect the attached object only when the attached object reflects light so that the captured image temporarily cannot be seen, and when the attached object does not reflect light, it is preferable not to detect the attached object. Thus, a conventional technology needs to be improved to accurately detect an attached object, such as the snow melting agent.

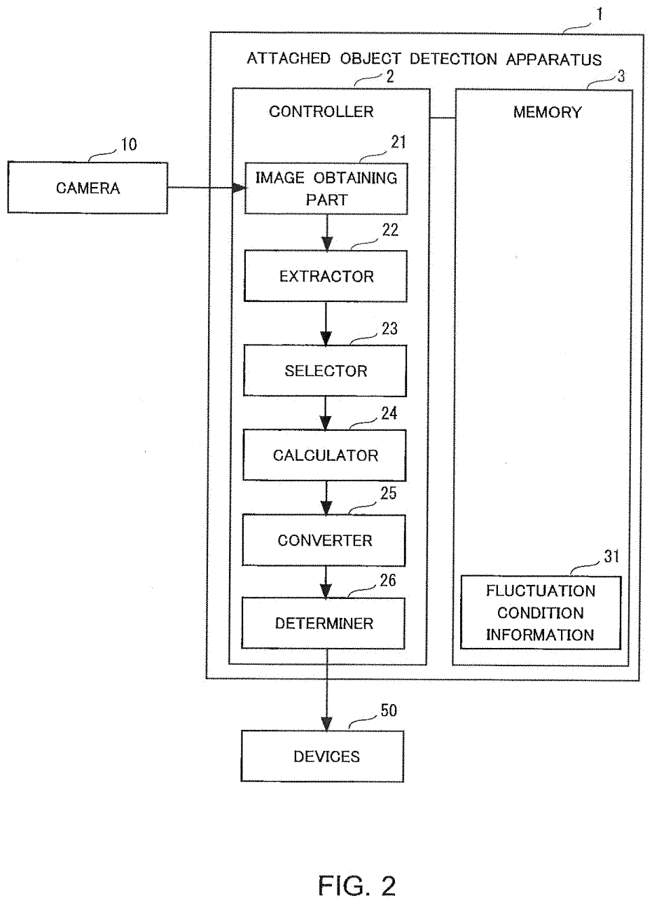

An attached object detection apparatus 1 of the embodiment (see FIG. 2) executes the attached object detection method so as to accurately detect the object, such as the snow melting agent, on the lens of the camera. The attached object is not limited to a snow melting agent, but may be an object that temporarily makes the background image unseeable due to light reflection.

More specifically, the attached object detection method of the embodiment first extracts, based on an edge of each pixel of the captured image I captured by the camera, a candidate region 100 that is a candidate for an attached object region that corresponds to a region having an object attached to the camera (a step S1). The attached object detection method of this embodiment extracts, as the candidate region 100, a rectangular region including a circular-shaped outline, for example, by a matching processing, such as a pattern matching,

Next, the attached object detection method of this embodiment selects a selection region 200 from amongst the extracted candidate regions 100 (a step S2). The selection region 200 is the candidate region 100 satisfying predetermined selection conditions that include a region size and a luminance summary value. Here, the teen “luminance summary value” means a value representing a statistical distribution of luminance in a predetermined region. For example, the “luminance summary value” is a descriptive statistics value, such as an average value, a mean value and a mode value, of statistical distribution of luminance values. This embodiment will describe the attached object detection method below, taking average values as an example. For example, the attached object detection method of this embodiment selects, as the selection region 200 satisfying the conditions, the candidate region 100 that has a region size smaller than a predetermined threshold and also has a luminance average greater than a predetermined threshold. In other words, the attached object detection method of this embodiment selects, as the selection region 200, the candidate region 100 of which the region size smaller than a region size of a raindrop and of which the luminance average greater than an average luminance value of a region of the raindrop.

Next, the attached object detection method of this embodiment determines, based on up and down (fluctuation) of luminance distribution of pixels in the selected selection region 200, whether or not the candidate region 100 is the attached object region (a step S3). The “luminance distribution of the pixels” means here a pattern of change in the luminance in a predetermined direction in a target image. For example, a predetermined coordinate (x0, y0) in the image is set as an origin. In a case in which luminance of a pixel in a horizontal direction x is L (x), a plotted pattern of the graph x-L (x) is referred to as the luminance distribution of the pixels in the horizontal direction having the origin (x0, y0). The x0 and the y0 can be freely or arbitrarily set, and a direction and an angle, including a vertical direction, can be also set freely.

In FIG. 1, a middle drawing illustrates the luminance distribution of the attached object region having the snow melting agent reflecting light. More specifically, in the luminance distribution, luminance of a center region of the attached object region is higher than luminance of a surrounding end region and also luminance of the center region is even overall. In other words, in a case where the snow melting agent reflects light, the center region of the object attached region tends to have a flat fluctuation of the luminance distribution.

The graph showing the luminance distribution in FIG. 1 shows the luminance distribution of pixels in a row lining in the horizontal direction in the candidate region 100. In the graph, luminance data of a bar corresponding to each “position” in a horizontal axis is a representative luminance value of a unit region that is generated by dividing a pixel line by a predetermined number of pixels. The unit region, calculation of the representative luminance value, etc. will be described later.

Thus, focusing on such a tendency, in the attached object detection method of this embodiment, in a case where the luminance distribution of the selection region 200 has a similar fluctuation to a predetermined fluctuation of the luminance distribution of the attached object, the selection region 200 is determined to be the object attached region, having, for example, the snow melting agent. Meanwhile, in a case where the snow melting agent does not reflect light, since the background image can be seen through the snow melting agent, the fluctuation is not flat. Thus, the attached object detection method of this embodiment does not detect the snow melting agent not reflecting light.

Thus, the attached object detection method of this embodiment detects the attached object, such as the snow melting agent, only in the case where the attached object reflects light so that the background image temporarily cannot be seen, and does not detect the attached object in the case where the attached object does not reflect light. In other words, the attached objects can be detected accurately by the attached object detection method of this embodiment.

By use of the attached object detection method of this embodiment, the attached object region can be determined based on an amount of change in fluctuation of the luminance distribution. This will be described later. The change in the fluctuation is defined here as a pattern showing a change amount of luminance of the pixels lining in a predetermined direction in the target image. The change amount of the luminance is, more specifically, a derivative value, a difference value, etc.

With reference to FIG. 2, a configuration of the attached object detection apparatus 1 of this embodiment will be described next. FIG. 2 is a block diagram showing the configuration of the attached object detection apparatus I of this embodiment. As shown in FIG. 2, the attached object detection apparatus 1 of this embodiment is connected to a camera 10 and a variety of devices 50. FIG. 2 illustrates the attached object detection apparatus 1 configured as a separate unit from the camera 10 and the devices 50. However, the configuration of the attached object detection apparatus 1 is not limited to this. The attached object detection apparatus 1 may be configured as one unit with the camera 10 or with one of the devices 50.

The camera 10 is a vehicle-mounted camera that includes, for example, a lens, such as a fisheye lens, and an image capturing sensor, such as a charge coupled device (CCD) and a complementary metal oxide semiconductor (CMOS). The camera 10 is installed in each of positions, for example, to capture images showing front, rear and side areas of the vehicle. The camera 10 outputs the captured image I to the attached object detection apparatus 1.

The devices 50 obtain a detection result detected by the attached object detection apparatus 1 to perform various controls for the vehicle. The devices 50, for example, include a display apparatus that gives information to a user about the attached object attached to the lens of the camera 10 and gives a message to the user that the attached object needs to be removed. Other examples of the devices 50 are a removal apparatus that removes the attached object from the lens by ejecting fluid, air, or the like toward the lens, and a vehicle control apparatus that controls autonomous driving of the vehicle, etc.

As shown in FIG. 2, the attached object detection apparatus 1 of this embodiment includes a controller 2 and a memory 3. The controller 2 includes an image obtaining part 21, an extractor 22, a selector 23, a calculator 24, a converter 25, and a determiner 26. The memory 3 stores fluctuation condition information 31.

The attached object detection apparatus 1 includes, for example, a computer and other circuits. The computer includes a central processing unit (CPU), a read only memory (ROM), a random access memory (RAM), a data flash, an in/out port, etc.

The CPU of the computer reads out and executes a program stored in the ROM so as to function as the image obtaining part 21, the extractor 22, the selector 23, the calculator 24, the converter 25, and the determiner 26 of the controller 2.

Moreover, at least one or all of the image obtaining part 21, the extractor 22, the selector 23, the calculator 24, the converter 25, and the determiner 26 of the controller 2 may be configured by hardware, such as an application specific integrated circuit (ASIC) and field programmable gate array (FPGA).

The memory 3 is, for example, a RAM or a data flash memory. The RAM or the data flash memory stores the fluctuation condition information 31, information of programs, etc. The attached object detection apparatus I may obtain the foregoing programs and information from a portable memory or from another computer connected to the attached object detection apparatus 1 via a wireless or wired network.

The fluctuation condition information 31 stored in the memory 3 is information including a condition that is a criterion for a determination process, described later, performed by the determiner 26. An example of the condition is a pattern condition for the fluctuation of the luminance distribution. The pattern condition includes a fluctuation pattern when the luminance distribution is mapped, a pattern of luminance data of pixels in a row/column of the luminance distribution, etc. The determination process that uses the fluctuation condition information 31 will be described later.

The controller 2 i) extracts, based on the edges detected from the pixels of the captured image I captured by the camera 10, the candidate region 100 for the attached object region, and ii) selects, from amongst the extracted candidate regions 100, the candidate region 100 satisfying the predetermined selection conditions as the selection region 200. Moreover, the controller 2 determines, based on the fluctuation of the luminance distribution of pixels in the selected selection region 200, whether or not the selection region 200 is the attached object region.

The image obtaining part 21 obtains the image captured by the camera 10 to generate (obtain) the current captured image I that is a current frame. More specifically, the image obtaining part 21 performs grayscale processing that converts pixels of the obtained captured image into gray level from white to black based on luminance of the pixels of the captured image.

The image obtaining part 21 performs a thinning process of the pixels in the obtained captured image to generate an image having a reduced size as compared to the obtained captured image. The image obtaining part 21 generates an integral image from values of the pixels and an integral image from square values of the pixels, based on the thinned captured image. The values of the pixels are information about luminance and edges of the pixels.

As a result, since the attached object detection apparatus 1 performs the thinning process of the obtained captured images, and generates the integral images, the attached object detection apparatus I speeds up calculation in a later process so that the attached object can be detected in a shorter processing time period.

The image obtaining part 21 may perform a smoothing process of the pixels, using a smoothing filter, such as an averaging filter. Further, the image obtaining part 21 may generate the current frame having a same size as a size of the obtained captured image, without performing the thinning process.

The extractor 22 extracts the candidate region 100 for the attached object region from the captured image I obtained by the image obtaining part 21. More specifically, the extractor 22 first extracts the luminance information and the edge information of each of the pixels in the captured image I. The luminance of each pixel is expressed by, for example, a parameter from 0 to 255.

The extractor 22 performs an edge detection process based on the luminance of each pixel to detect the edges in an X-axis direction (a left-right direction of the captured image I) and a Y-axis direction (an up-down direction of the captured image I) of the pixel. Any edge detection filter, for example, a sobel filter or a prewitt filter, may be used for the edge detection process. The extractor 22 detects, as the edge information, a vector that includes information of an edge angle and an edge strength of the pixel, using trigonometric function based on the edge in the X-axis direction and the edge in the Y-axis direction. More specifically, the edge angle is expressed by a direction of the vector, and the edge strength is expressed by a length of the vector.

The extractor 22 performs the matching process (template matching) that matches the detected edge information with preliminarily prepared template information that shows an outline of an attached object, to extract the edge information similar to the template information. Then, the extractor 22 extracts a region corresponding to the extracted edge information, i.e., the extractor 22 extracts the rectangular candidate region 100 including the outline of the attached object.

The selector 23 selects, as the selection region 200, the candidate region 100 satisfying the predetermined selection conditions that include the region size and the luminance average, from amongst the candidate regions 100 extracted by the extractor 22. For example, the selector 23 selects, as the selection region 200, the candidate region 100 having the region size smaller than the predetermined threshold (e.g. 80 pixels) and the luminance average equal to or greater than the predetermined threshold (e.g. 100).

More specifically, the selector 23 selects the selection region 200 based on the selection conditions that include the region size and the luminance average that discriminate the selection region 200 from a raindrop. In other words, the selector 23 selects the selection region 200 based on features of the snow melting agent that has the region size smaller than a raindrop and the luminance average greater than the raindrop. The thresholds that discriminate the snow melting agent from the raindrop can be set by a preliminary experiment and the like. Thus, it is possible to separate the attached object like the snow melting agent that temporarily makes the background image unseeable from the attached object like a raindrop that continuously masks the background image.

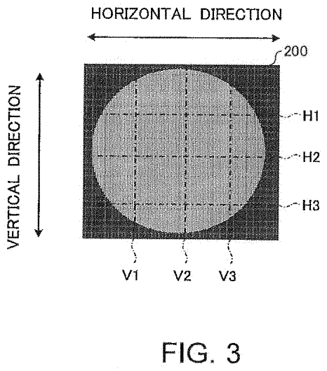

Next, the selector 23 extracts the luminance distribution of pixels in a predetermined row in the selected selection region 200. FIG. 3 illustrates the row of the pixels to be extracted for the luminance distribution. As shown in FIG. 3, the selector 23 extracts the luminance distribution of three pixel rows H1 to H3 in the horizontal direction and three pixel columns V1 to V3 in the vertical direction in the captured image I.

The selector 23 may extract rows/columns of pixels in one of the horizontal direction and the vertical direction. Number of the extracted rows and columns are three in this embodiment. However, the number is not limited to three, and the number may be two or less or four or more.

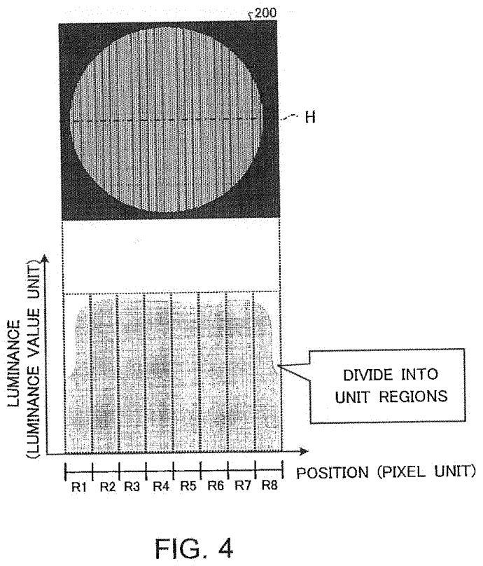

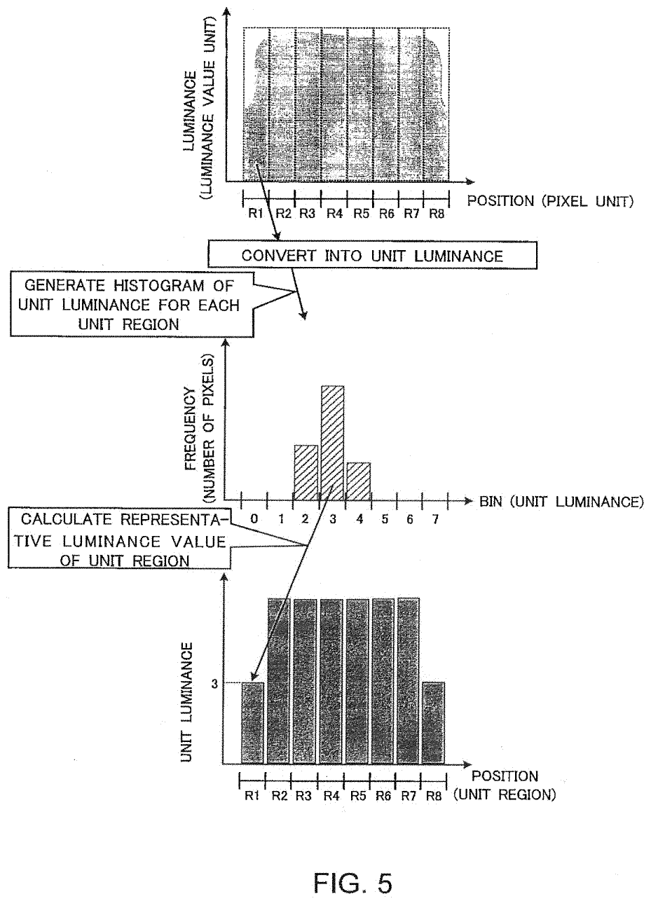

With reference back to FIG. 2, the calculator 24 will be described. The calculator 24 divides the selection region 200 selected by the selector 23 into the unit regions, i.e., predetermined number of pixels is set as a unit, and the selection region 200 is divided by the unit into the unit regions. Then, the calculator 24 calculates a representative luminance value for each unit region. A calculation method of the representative luminance value that is used by the calculator 24 will be described later with reference to FIGS. 4 and 5.

A predetermined range of luminance is set as a unit, and the converter 25 converts luminance of pixels in the selection region 200 into unit luminance. For example, the converter 25 converts the parameter (values) indicative of luminance from 0 (zero) to 255, into the unit luminance by dividing the parameter of luminance by the predetermined range as a unit. The representative luminance value that is calculated by the calculator 24, described above, can be expressed by the unit luminance that is converted by the converter 25. This will be described with reference to FIGS. 4 and 5.

FIGS. 4 and 5 illustrate a process that is performed by the calculator 24. First will be described with reference to FIG. 4 is a method for setting the unit region that is set by the calculator 24. FIG. 4 illustrates the luminance distribution of a pixel row H in the horizontal direction.

As shown in FIG. 4, the calculator 24 divides the horizontal pixel row into, for example, eight unit regions R1 to R8 (hereinafter also referred to collectively as “unit regions R”). Widths (number of pixels) of the unit regions R1 to R8 may be same (i.e., equally divided) or may be different from one another.

Number of the divided unit regions R may be set freely. It is recommended that the number of the divided unit regions R (eight in FIG. 4) should be unchanged regardless of size of the selection region 200 that is selected from the captured image I. Thus, since the number of the unit regions R is unchanged even if the sizes of the selected selection region 200 are varied, derived information is consistent so that the processing load in the later process and the like will be reduced.

Next, as shown in FIG. 5, the calculator 24 calculates the representative luminance value for each unit region R. As shown in an upper drawing of FIG. 5, the converter 25 converts luminance (e.g., 0 to 255) of each pixel into the unit luminance prior to the calculation of the representative luminance value by the calculator 24. More specifically, in FIG. 5, the luminance parameter from 0 to 255 is equally divided into eight to be converted into the unit luminance, shown as “0” to “7” in a middle drawing in FIG. 5: In this case, a luminance value range for each is 32 in the unit luminance. For example, “0 (zero)” in the unit luminance corresponds to luminance values from 0 to 31, and “1” in the unit luminance corresponds to luminance values from 32 to 63. In other words, the conversion into the unit luminance is a processing of reducing number of divisions of the luminance parameter. Since the number of the divisions of the luminance parameter in the luminance distribution can be reduced to desired number of divisions, the processing load in the later process can be reduced. In the conversion from luminance to the unit luminance, the number of the divisions and the range for each division are freely settable. The unit luminance is equally divided in the foregoing description, but may not be equally divided.

Then, the calculator 24 generates a histogram of the unit luminance for each of the unit regions R1 to R8. The middle drawing in FIG. 5 shows the histogram of the unit region R1, having bin representing the unit luminance 0 to 7, and frequency representing number of pixels.

Next, as shown in a lower drawing in FIG. 5, the calculator 24 calculates the representative luminance value for each of the unit regions R, based on the generated histograms. For example, in a case of the unit region R1, the calculator 24 finds a bin having a most frequent value (bin “3” in FIG. 5) of the unit luminance in the histogram, and calculates the value of the unit luminance as the representative luminance value of the unit region R1. Since number of the luminance distribution data is reduced from number of pixels to number of the unit regions R, the processing load in the later step can be reduced.

The calculator 24 determines the unit luminance of the most frequent value as the representative value. However, the representative value is not limited to this. For example, the calculator 24 may determine a median value, an average value or the like in the histogram as the representative value.

The calculator 24 calculates the representative luminance value based on the histogram, but calculation is not limited to that. For example, the calculator 24 may calculate an average luminance value for each of the unit regions R, and may find and determine a value of the unit luminance corresponding to the calculated average luminance value as the representative value.

The calculator 24 determines the representative value in the unit luminance. However, the calculator 24 may use an average luminance value and the like of the unit regions R as the representative value. In other words, the representative value may be expressed by the unit luminance or the luminance value.

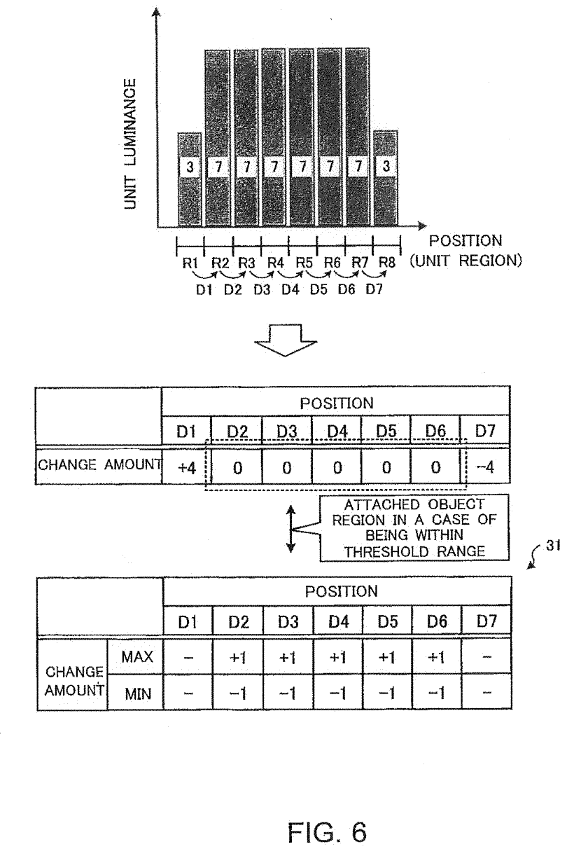

The determiner 26 determines, based on the fluctuation of the luminance distribution of the pixels in the selection region 200, whether or not the selection region 200 is the attached object region. With reference to FIGS. 6 to 11, the determination processes that are performed by the determiner 26 will be described here.

FIGS. 6 to 11 illustrate the processes that are performed by the determiner 26.

An upper drawing in FIG. 6 illustrates the luminance distribution of one selection region 200. The representative values of the unit regions R1 to R8 are shown in bars.

As shown in the upper drawing in FIG. 6, the determiner 26 calculates change amounts D1 to D7 of the unit luminance between two adjacent unit regions amongst the unit regions R1 to R8. More specifically, the determiner 26 calculates, as change amounts, differences in unit luminance between the two adjacent unit regions. In other words, the determiner 26 calculates, as the change amount, a change in luminance between the two adjacent unit regions. The change amount is here simply the differences of the unit luminance between the two adjacent unit regions. However, a calculating method for the change amounts is not limited to this. For example, the determiner 26 may generate a continuous function indicating the luminance distribution by use of a completing method, and may calculate a derivative value of the continuous function as the change amount. A lower drawing (an upper table) in FIG. 6 is a table having the change amounts D1 to D7.

When a fluctuation pattern of the luminance distribution satisfies a predetermined pattern of change, the determiner 26 determines that the selection region 200 is the attached object region. More specifically; the determiner 26 compares each of the change amounts D1 to D7 with the fluctuation condition information 31 stored in the memory 3 to perform the determination process.

The lower drawing (a lower table) in FIG. 6 is a table including threshold ranges for the change amounts D1 to D7, as an example of the fluctuation condition information 31. In a case where the change amounts D1 to D7 of the selection region 200 are within the threshold ranges of the change amounts D1 to D7 in the fluctuation condition information 31, the determiner 26 determines that the candidate region 100 is the attached object region.

In other words, in a case where the pattern of the change amounts D1 to D7 of the unit luminance of the adjacent unit regions R1 to R8 satisfies the threshold ranges set in the fluctuation condition information 31, the determiner 26 determines that the region is the attached object region.

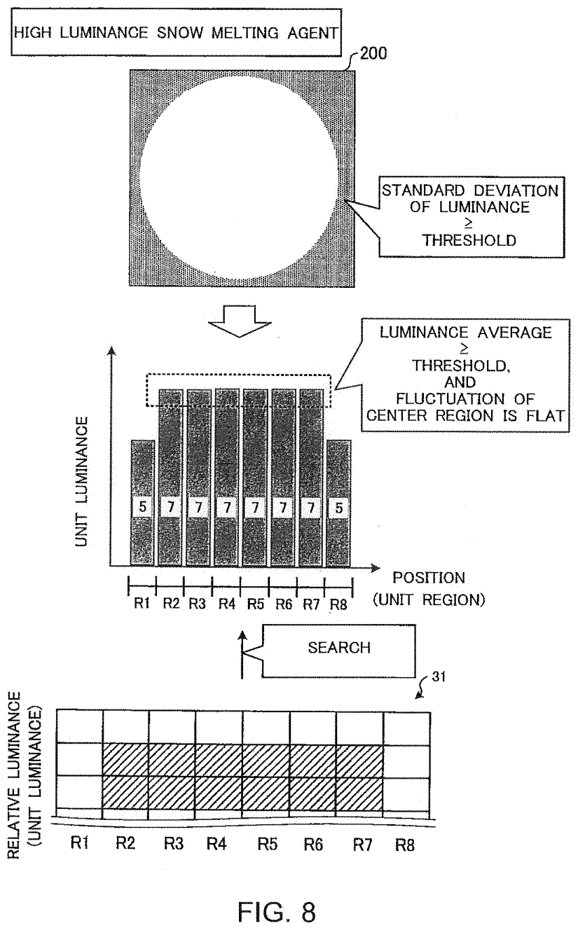

In the fluctuation condition information 31 shown in FIG. 6, the threshold ranges are not set for the change amounts D1 and D7. This means that the change amounts D1 and D7 are arbitrary (any value). In other words, in a case where the threshold ranges of the change amounts D2 to D6 are satisfied, the determiner 26 determines the selection region 200 as the attached object region. There are mainly three types of patterns for the threshold range in the fluctuation condition information 31. The three types of the threshold range patterns will be described later with reference to FIG. 8 to FIG. 10.

The determiner 26 uses the change amounts D1 to D7 so as to disregard whether values in luminance of the unit regions R are high or low. Thus, the attached object detection apparatus 1 reduces a determination error caused by a high luminance value or a low luminance value. Further, since the determiner 26 does not need to set a determination condition for each luminance, a storage space for storing the condition can be saved, and the processing load can be reduced because there is no need to perform the determination process for each luminance.

Further, in order to give flexibility, a maximum change amount and a minimum change amount are set for the change amounts D1 to D7 in the fluctuation condition infatuation 31. Thus, the attached object detection apparatus 1 detects the attached object region even if the attached object region has a distorted shape. In other words, even if an attached object has a different shape, the attached object detection apparatus 1 accurately detects the attached object region.

FIG. 6 shows the case in which the threshold ranges are set for the five change amounts D2 to D6 in the fluctuation condition information 31. However, the threshold ranges may be set for 6 or more or 4 or less. In other words, number of change amounts for which the threshold ranges are set may be varied depending on a size of the attached object to be detected.

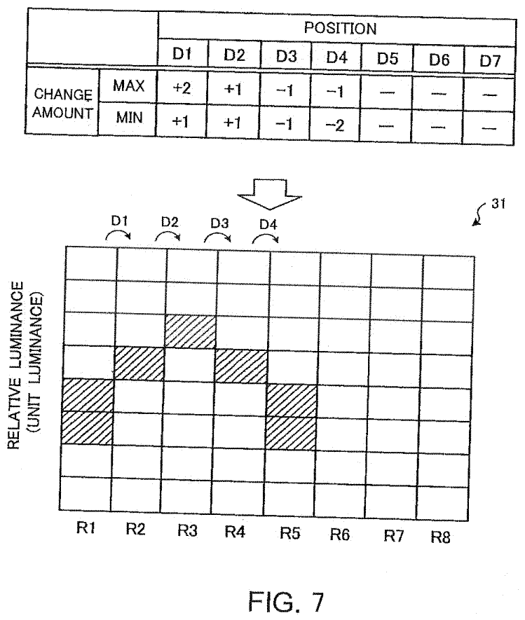

Moreover, FIG. 6 shows the case in which the determiner 26 determines the attached object region based on whether or not the change amount is included in the threshold range in the fluctuation condition information 31. However, for example, the determiner 26 may determine the attached object region based on the fluctuation condition information 31 having a mapped fluctuation of the luminance distribution. The fluctuation of the luminance distribution has been mapped based on the threshold ranges for the change amounts D1 to D7. This will be described with reference to FIG. 7.

An upper drawing in FIG. 7 illustrates the threshold ranges for the change amounts of the fluctuation of the luminance distribution. A lower drawing in FIG. 7 illustrates the fluctuation condition information 31 having the mapped threshold ranges for the change amounts D1 to D4 shown in the upper drawing in FIG. 7. More specifically, the lower drawing in FIG. 7 is a map having a horizontal axis representing positions of the unit regions R1 to R8, and a vertical axis representing relative luminance. The map is preliminarily generated.

For example, since the change amount D1 has a threshold range from +1 to +2, two blocks in predetermined positions of the relative luminance are set as a threshold for the unit region R1. One block is set for the unit region R2 in a position that satisfies the threshold range for the change amount D1. Next, since the change amount D2 has a value +1, a threshold is set at a block of the unit region R3 that is one block higher than the block set for the unit region R2. Next, since the change amount D3 has a value −1, a threshold is set at a block of the unit region R4 that is one block lower than the block set for the unit region R3. Next, since the change amount D4 has a threshold range from −2 to −1, a threshold is set in two blocks of the unit region R5 that is one and two blocks lower than the block set for the unit region R4. Thus, the map of the fluctuation condition information 31 is completed.

In other words, the map in the fluctuation condition information 31 is information indicating the fluctuation pattern of the unit luminance in the unit regions R1 to R5, based on the change amounts D1 to D4. As for the unit regions R6 to R8, since the threshold ranges are not set for the change amounts D5 to D7, there is no problem with any luminance detected in the unit regions R6 to R8.

The determiner 26 generates the map based on the change amounts D1 to D7 of the unit regions R1 to R8 in the selected selection region 200 by a similar method to the foregoing method. Then, the determiner 26 performs a matching process for checking whether the generated map matches the map in the fluctuation condition information 31. In a case where those maps match each other, the determiner 26 determines that the selection region 200 is the attached object region.

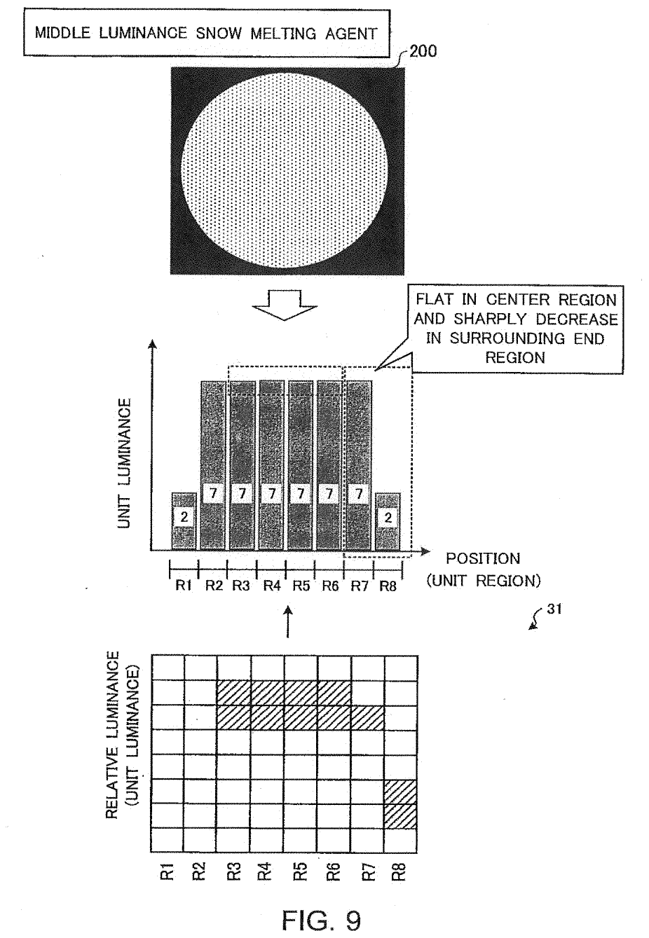

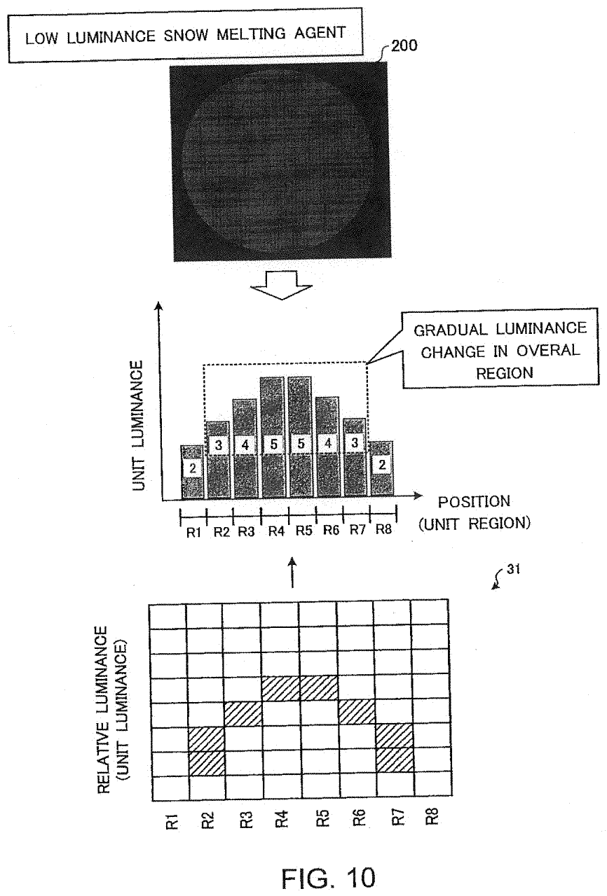

Here, a concrete example of the fluctuation condition information 31 will be described with reference to FIGS. 8 to 10. FIG. 8 illustrates the fluctuation condition information 31 for a high luminance snow melting agent. FIG. 9 illustrates the fluctuation condition information 31 for a middle luminance snow melting agent. FIG. 10 illustrates the fluctuation condition information 31 for a low luminance snow melting agent. In other words, in a case where the selection region 200 satisfies any of the threshold ranges that are set for luminance levels of the snow melting agents, the determiner 26 determines the selection region 200 as the attached object region.

First, with reference to FIG. 8, a determination process for the high luminance snow melting agent will be described. FIG. 8 illustrates the selection region 200 including a region of the high luminance snow melting agent. As shown in FIG. 8, the region of the high luminance snow melting agent is the attached object region having the snow melting agent that reflects light brightly due to light reflection so that luminance of a surrounding end region of the snow melting agent increases as luminance of the region of the snow melting agent increases. In other words, in a case of the high luminance snow melting agent, the luminance of the overall selection region 200 is relatively high.

The determiner 26 performs the determination process based on this feature of the luminance. More specifically, the determiner 26 selects a selection region 200 having luminance variation equal to or greater than a threshold (e.g. 10) from amongst the selection regions 200. The luminance variation, here, is a value indicative of dispersion of the luminance distribution in a predetermined region. For example, standard deviation, variance, range between largest and least elements, interquartile range, arbitrary percentile range, etc. are some among descriptive statistics values of the luminance distribution. This embodiment will describe an example by use of standard deviation. However, this invention is not limited to standard deviation. Thus, the selection region 200 overall overexposed can be excluded.

Next, when each change amount of fluctuation in a center region of the selected selection region 200 is within a predetermined threshold range I and also when a luminance average of the selected selection region 200 is equal to or greater than a high luminance threshold (e.g. 200), the determiner 26 determines that the selected selection region 200 is the attached object region.

As an example, FIG. 8 illustrates a map of the fluctuation condition information 31 indicating that the unit regions R2 to R7 have a relative luminance equal to or greater than the predetermined value (corresponding to the high luminance threshold) and that fluctuation of the luminance distribution of the unit regions R2 to R7 is flat (corresponding to the change amount within the predetermined threshold range 1).

In other words, the determiner 26 determines, based on the fluctuation condition information 31, whether or not the fluctuation of the luminance distribution of the unit regions R2 to R7 obtained from the selection region 200 is flat. In a case where the fluctuation of the luminance distribution of the unit regions R2 to R7 is flat, the determiner 26 determines that the selection region 200 is the attached object region having the high luminance snow meting agent.

In other words, the determiner 26 determines the attached object region based on the feature of the high luminance snow melting agent of which an overall region reflects light brightly so that the luminance of the overall selection region 200 becomes high luminance. Thus, it is possible to accurately detect the attached object region of the high luminance snow melting agent.

FIG. 8 illustrates the condition that the fluctuation of the six unit regions R2 to R7 is flat in the fluctuation condition information 31. However, the fluctuation condition information 31 may include a condition that fluctuation of five or smaller number of the unit regions is flat.

Next, with reference to FIG. 9, a determination process for the middle luminance snow melting agent will be described. FIG. 9 illustrates the selection region 200 including a region of the middle luminance snow melting agent. As shown in FIG. 9, the region of the middle luminance snow melting agent is a region having a feature of luminance intermediate between the high luminance snow melting agent, described above, and the low luminance melting agent, described later. More specifically, the middle luminance snow melting agent is the attached object region that reflects light brightly in the region of the snow melting agent, like the high luminance snow melting agent, while luminance of the surrounding end region of the snow melting agent does not much increases. In other words, in a case of the middle luminance snow melting agent, difference in luminance between the region of the snow melting agent and a region other than the snow melting region is relatively great in the selection region 200.

When a change amount of fluctuation in the center region of the selected selection region 200 is within a predetermined threshold range 2 and also when a difference in luminance between the center region and the surrounding end region in the selection region 200 is equal to or greater than a predetermined difference threshold, the determiner 26 determines that the selection region 200 is the attached object region of the middle luminance snow melting region.

As an example, FIG. 9 illustrates a map of the fluctuation condition information 31 indicating that the fluctuation of the luminance distribution of the unit regions R3 to R7 is flat, among the unit regions R3 to R8, and that a difference in luminance between the unit region 7 and the unit region 8 is equal to or greater than the predetermined difference threshold.

In other words, the determiner 26 determines, based on the fluctuation condition information 31, whether or not the fluctuation of the luminance distribution of the unit regions R3 to R7 obtained from the selection region 200 is flat and whether or not the luminance of the unit region R8 sharply decreases. In a case where the fluctuation of the luminance distribution of the unit regions R2 to R8 matches a predetermined fluctuation, the determiner 26 determines that the selection region 200 is the attached object region having the middle luminance snow melting agent.

In other words, the determiner 26 performs the determination process based on the feature that the center region corresponding to a region of the snow melting region is bright and that the surrounding end region is dark due to the background image. Thus, it is possible to accurately detect the attached object region of the middle luminance snow melting agent.

FIG. 9 shows the fluctuation condition information 31 for a case where the luminance of the unit region R8 sharply decreases. However, the fluctuation condition information 31 may include fluctuation condition information 31 for a case in which luminance of the unit region R1 decreases sharply and/or a case in which luminance of the unit region R1 and luminance of the unit region R8 decrease sharply.

Next, with reference to FIG. 10, a determination process for the low luminance snow melting agent will be described. FIG. 10 illustrates the selection region 200 including a region of the low luminance snow melting agent. As shown in FIG. 10, the region of the low luminance snow melting agent is a region of which luminance is more affected by the background image than light reflection by the snow melting agent. More specifically, in a case of the attached object region having the low luminance snow melting agent, while the center region of the snow melting agent reflects light slightly whitely, luminance of the surrounding end region of the snow melting agent little increases due to the background image. In other words, in a case of the low luminance snow melting agent, the luminance of the overall selection region 200 is relatively low.

When a change amount of the fluctuation distribution in the selected selection region 200 is within a predetermined threshold range 3 and also when luminance gradually increases from the surrounding end region to the center region in the selection region 200, the determiner 26 determines that the selection region 200 is the attached object region.

As an example, FIG. 10 illustrates a map of the fluctuation condition information 31 indicating that the change amounts of the unit regions R2 to R7 are equal to or smaller than 2 (absolute value), and the luminance gradually increases toward the unit regions R4 and R5, the center region.

In other words, the determiner 26 determines, based on the fluctuation condition information 31, that the selection region 200 is the low luminance snow melting reason when the change amount of the fluctuation of the luminance distribution of the unit regions R2 to R7 obtained from the selection region 200 is 2 or smaller, and when the luminance gradually increases toward the unit region R4 and R5.

In other words, the determiner 26 performs the determination process based on the feature of the low luminance snow melting agent that the luminance gradually changes toward the center region corresponding to the region of the snow melting agent. Thus, it is possible to accurately detect the attached object region of the low luminance snow melting agent.

FIG. 10 illustrates the case in which the fluctuation of the six unit regions R2 to R7 is set in the fluctuation condition information 31. However, fluctuation of 5 unit regions or smaller or 7 unit regions may be set.

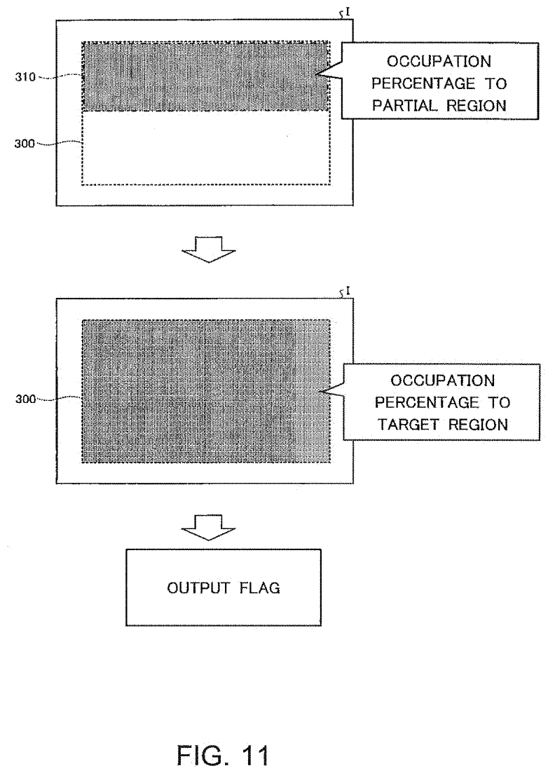

Next, the determiner 26 calculates an occupation percentage of the attached object region to a predetermined region in the captured image I. The determiner 26 outputs an attached object flag to devices 50 based on the occupation percentage. This will be described with reference to FIG. 11.

FIG. 11 illustrates a target region 300 to be set in the captured image I. The target region 300 is a predetermined region of the captured image I. In a case where an attached object is attached to a portion of the lens corresponding to the target region 300, a process that uses the captured image I, such as a parking line detection process and an autonomous parking process, cannot be accurately performed. The target region 300 is, for example, a rectangular region.

As shown in an upper drawing of FIG. 11, the determiner 26 performs a determination process based on the selection region 200 included in a partial region 310 that is a portion of the target region 300. The partial region 310 is, for example, an upper region of the target region 300 because a light is provided above the camera so that the upper region of the target region 300 is more affected by the attached object that reflects light. A position of the partial region 310 is properly settable according to an installation position of the camera and a body height of the vehicle, etc.

The determiner 26 calculates an occupation percentage that is a percentage of the attached object region to the partial region 310, and determines whether or not the occupation percentage is equal to or greater than a predetermined occupation threshold 1 (e.g. 40%). Then, in a case where the occupation percentage to the partial region 310 is equal to or greater than the predetermined occupation threshold 1, the determiner 26 calculates an occupation percentage that is a percentage of the attached object region to the target region 300, and determines whether or not the occupation percentage is equal to or greater than a predetermined occupation threshold 2 (e.g. 40%).

In other words, the determiner 26 performs a preliminary determination by use of the partial region 310 that is more affected by the attached object that reflects light. In a case where the occupation percentage is equal to or the greater than the occupation threshold 1 in the preliminary determination, the determiner 26 performs the determination process of the occupation percentage by use of the target region 300. Thus, it is possible to accurately detect the attached object that reflects light.

Then, in the case where the occupation percentage to the target region 300 is equal to or greater than the predetermined occupation threshold 2, the determiner 26 outputs to the devices 50 the attached object flag indicative of ON that indicates that the attached object is attached to the lens.

In the case where the occupation percentage to the target region 300 is smaller than the predetermined occupation threshold 2, the determiner 26 outputs to the devices 50 the attached object flag indicative of OFF that indicates that no attached object is attached to the lens. A state in which the occupation percentage to the partial region 310 is equal to or greater than the occupation threshold 1 and the occupation percentage to the target region 300 is smaller than the occupation threshold 2, a lower region of the partial region 310 is little affected by the attached object that reflects light so that the background image can be seen. The lower region of the partial region 310 is a necessary region for a control process of the devices 50.

In other words, even in the case where the attached object that reflects light is on the partial region 310, if the background image can be seen in the lower region, the determiner 26 outputs the attached object flag indicative of OFF due to no effect on the control process of the devices 50.

Thus, it is possible to reduce a frequency of outputting the attached object flag indicative of OFF regarding the captured image I that is used for the control process of the devices 50. Accordingly, a break or a discontinuation of the control process of the devices 50 can be reduced.

Information about ON or OFF of the attached object flag is information about validity about whether or not the captured image I of a current frame can be used by the devices 50, or information about credibility of the control performed by the devices 50 by use of the captured image I. Therefore, the determiner 26 may output to the devices 50 information indicative of the validity or the credibility of the captured image I, instead of the information about the attached object flag.

As shown in FIG. 11, the determiner 26 performs the determination process of the occupation percentage to each of the partial region 310 and the target region 300. However, the determiner 26 may perform only one of the determination processes of the occupation percentage to the partial region 310 and the occupation percentage to the target region 300. Moreover, the partial region 310 is not limited to one region but may be a plurality of regions.

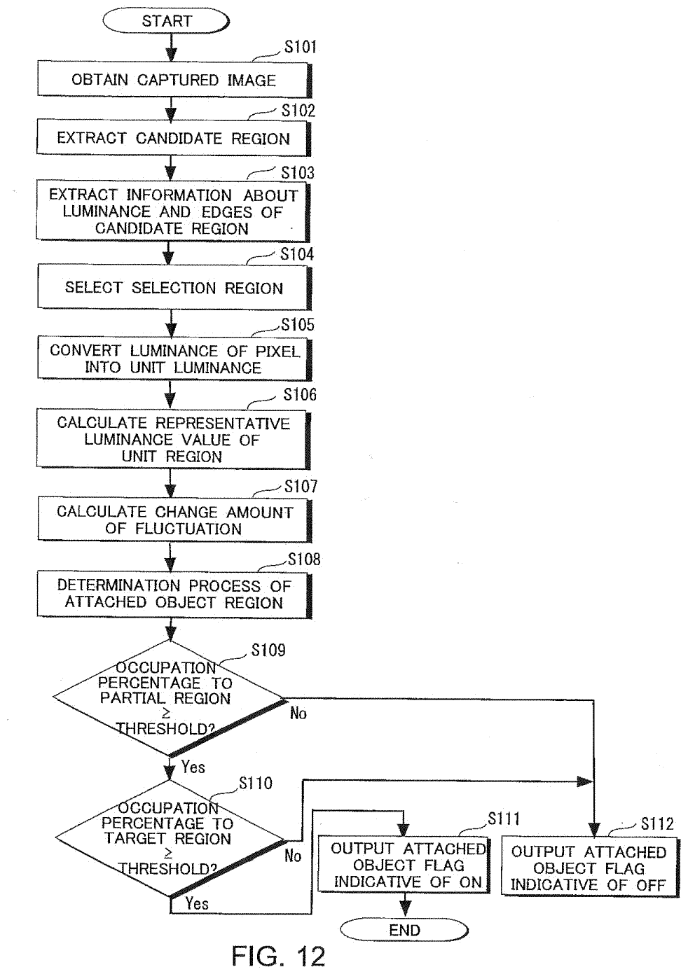

Next, with reference to FIG. 12, process steps of the process that is performed by the attached object detection apparatus 1 of this embodiment will be described. FIG. 12 is a flowchart showing the process steps of the attached object detection process that is performed by the attached object detection apparatus 1 of this embodiment.

As shown in FIG. 12, the image obtaining part 21 first obtains an image captured by the camera 10, and performs the grayscale processing and the thinning process of the obtained image. After those processing, the image obtaining part 21 obtains, as the captured image I, an integral image generated based on values of pixels in the reduced image (a step S101).

Next, the extractor 22 extracts the candidate region 100 for the attached object region corresponding to the attached object attached to the camera 10, based on the edges detected from the pixels in the captured image I obtained by the image obtaining part 21 (a step S102).

Moreover, the extractor 22 extracts the information about the luminance and the edges of the candidate region 100 (a step S103). Next, the selector 23 selects, from amongst the candidate regions 100 extracted by the extractor 22, the candidate region 100 satisfying the predetermined selection conditions that include the region size and the luminance average, as the selection region 200 (a step S104).

Next, the converter 25 converts the luminance of the pixels in the selection region 200 into the unit luminance that is generated by dividing the luminance by the predetermined range as a unit (a step S105).

Next, the calculator 24 divides the selection region 200 into the predetermined number of the unit regions R, and calculates the representative luminance value of each of the unit regions R (a step S106). Next, the determiner 26 calculates the change amount of the fluctuation of the representative value of each unit region R in the selection region 200 (a step S107).

Next, the determiner 26 performs the determination process, based on the change amount of the fluctuation of the representative values of the selection region 200, to determine whether or not the selection region 200 is the attached object region (a step S108)

Next, the determiner 26 determines, based on a result of the determination process, whether or not the occupation percentage that is a percentage of the attached object region to the partial region 310 is equal to or greater than the predetermined occupation threshold 1 (a step S109). In a case where the occupation percentage to the partial region 310 is equal to or greater than the predetermined occupation threshold 1 (Yes in the step S109), the determiner 26 determines whether or not the occupation percentage of the attached object region to the target region 300 is equal to or greater than the predetermined occupation threshold 2 (a step S110).

In the case where the occupation percentage of the attached object region to the target region 300 is equal to or greater than the predetermined occupation threshold 2 (Yes in the step S110), the determiner 26 outputs the attached object flag indicative of ON (a step S111) and ends the process.

On the other hand, in the case where the occupation percentage of the attached object region to the target region 300 is smaller than the predetermined occupation threshold 2 (No in the step S110), the determiner 26 outputs the attached object flag indicative of OFF (a step S112) and ends the process.

Moreover, in the step S109, in the case where the occupation percentage of the attached object region to the partial region 310 is smaller than the predetermined occupation threshold 1 (No in the step S109), the determiner 26 outputs the attached object flag indicative of OFF (the step S112) and ends the process.

As described above, the attached object detection apparatus 1 of this embodiment includes the extractor 22, the selector 23, and the determiner 26. The extractor 22 extracts the candidate region 100 for the attached object region corresponding to an attached object attached to the camera 10 based on the edges detected from pixels of the captured image I captured by the camera 10. The selector 23 selects, as the selection region 200, the candidate region 100 satisfying the predetermined selection conditions that include the region size and the luminance average, from amongst the candidate regions 100 extracted by the extractor 22. The determiner 26 determines, based on the fluctuation of the luminance distribution of the pixels in the selection region 200 selected by the selector 23, whether or not the selection region 200 is the attached object region. Thus, the attached object detection apparatus 1 can accurately detect the attached object.

The foregoing embodiment uses the captured image I captured by the camera on the vehicle. The captured image I may be a captured image I captured by, for example, a security camera, a camera installed on a street light, etc. In other words, the captured image I may be any captured image captured by a camera of which a lens may have an attached object.

Further effects and modifications may be easily derived by a person skilled in the art. Therefore, a broader mode of the invention is not limited to the foregoing specific description and typical embodiments. Thus, various changes are possible without departing from the sprit or scope of the general concept of the invention defined by the attached claims and equivalents thereof.

While the invention has been shown and described in detail, the foregoing description is in all aspects illustrative and not restrictive. It is therefore understood that numerous other modifications and variations can be devised without departing from the scope of the invention.

What is claimed is:

1. An attached object detection apparatus comprising:
a memory; and
a controller coupled to the memory and configured to:
extract one or more candidate regions from a captured image captured by an image capturing apparatus, each of the one or more candidate regions being a candidate for being an attached object region corresponding to a portion of the captured image in which an attached object is attached to the image capturing apparatus, the one or more candidate regions being extracted based on edges detected from pixels of the captured image captured by the image capturing apparatus;
select, as one or more selection regions, one or more of the candidate regions satisfying predetermined selection conditions that include a region size and a descriptive statistics value, from amongst the extracted one or more candidate regions; and
determine, based on fluctuation of luminance distribution of pixels in the selected one or more selection regions, whether or not each of the one or more selection regions is the attached object region.

2. The attached object detection apparatus according to claim 1, wherein
the controller performs a determination process, based on the selection region included in a partial region that is a portion of a target region of the captured image.

3. The attached object detection apparatus according to claim 1, wherein
when a fluctuation pattern of the luminance distribution in the one or more selection regions satisfies a predetermined pattern of change, the controller determines that each of the one or more selection regions is the attached object region.

4. The attached object detection apparatus according to claim 3, wherein
when i) a change amount of the fluctuation in a center region of the selection region having luminance variation equal to or greater than a predetermined threshold is within a predetermined threshold range, from amongst the one or more selection regions, and ii) the descriptive statistics value of the selection region is equal to or greater than a predetermined high luminance threshold, the controller determines that the selection region is the attached object region.

5. The attached object detection apparatus according to claim 3, wherein
when i) a change amount of the fluctuation in a center region of the selection region is within a predetermined threshold range, from amongst the one or more selection regions, and ii) a difference in luminance between the center region and a surrounding end region in the selection region is equal to or greater than a predetermined threshold, the controller determines that the selection region is the attached object region.

6. The attached object detection apparatus according to claim 3, wherein
when i) a change amount of the fluctuation in the selection region is within a predetermined threshold range, from amongst the one or more selection regions, and ii) luminance gradually increases from a surrounding end region to a center region in the selection region, the controller determines that the selection region is the attached object region.

7. The attached object detection apparatus according to claim 1, wherein the controller is further configured to:
divide each of the one or more selection regions into unit regions by a predetermined number of pixels, and calculate a representative luminance value for each of the unit regions; and
determine, based on the fluctuation of the luminance distribution of the representative luminance values of each of the one or more selection regions, whether or not each of the one or more selection regions is the attached object region.

8. The attached object detection apparatus according to claim 1, wherein
the controller is further configured to:
convert luminance of the pixels in the one or more selection regions into unit luminance by a predetermined luminance range; and
determine, based on the fluctuation of the luminance distribution in the unit luminance, whether or not each of the one or more selection regions is the attached object region.

9. An attached object detection method comprising the steps of:
(a) extracting, by a controller, one or more candidate regions from a captured image captured by an image capturing apparatus, each of the one or more candidate regions being a candidate for being an attached object region corresponding to a portion of the captured image in which an attached object is attached to the image capturing apparatus, the one or more candidate regions being extracted based on edges detected from pixels of the captured image captured by the image capturing apparatus;
(b) selecting, by the controller, as one or more selection regions, one or more of the candidate regions satisfying predetermined selection conditions that include a region size and a descriptive statistics value, from amongst the one or more candidate regions extracted by the step (a); and
determining, by the controller, based on fluctuation of luminance distribution of pixels in the one or more selection regions selected by the step (b), whether or not each of the one or more selection regions is the attached object region.
